(19) United States
(12) Patent Application Publication
(10) Pub. No.: US 2023/0212073 A1
(43) Pub. Date: Jul. 6, 2023

(54) GROUT FOR THE INJECTION OF PRESTRESSING CABLES AND METHOD FOR INSTALLING A CABLE COMPRISING SUCH A GROUT

(71) Applicant: SOLETANCHE FREYSSINET, RUEIL MALMAISON (FR)

(72) Inventors: Christian TOURNEUR, LE MESNIL SAINT DENIS (FR); Julien MERCIER, VANVES (FR); Ivica ZIVANOVIC, GOUVIEUX (FR); Xavier HALLOPEAU, VÉLIZY-VILLACOUBLAY (FR)

(21) Appl. No.: 18/000,734

(22) PCT Filed: Jun. 3, 2021
(86) PCT No.: PCT/FR2021/051007

§ 371 Date: Dec. 5, 2022

(30) Foreign Application Priority Data
Jun. 5, 2020 (FR) 20 05925

(51) Int. Cl. C04B 28/00; E04G 21/12; C04B 18/08; C04B 12/00; C04B 7/24

(52) U.S. Cl. CPC C04B 28/006; E04G 21/12; C04B 18/08; C04B 12/005; C04B 7/243; C04B 2111/00146

(57) ABSTRACT

The invention relates to a geopolymer grout for protecting prestressing reinforcements, the geopolymer grout comprising metakaolin, fly ash and an activator mixture, the activator mixture comprising sodium hydroxide and sodium silicate, wherein the molar ratio Na₂O:SiO₂ of the sodium silicate is between 0.40 and 0.70.

### TECHNICAL FIELD

The present invention relates to the field of reinforcements for construction works. It relates more particularly to the grout injected into prestressing-cable ducts and to the process for manufacturing this grout, and also to the process for installing a structural cable comprising the fitting of a duct and the injection of a grout into the duct.

### PRIOR ART

Prestressing cables are generally composed of a bundle of reinforcements, often made of steel, the tensioning of which makes it possible to exert the prestress. The reinforcements are disposed in a tubular duct (generally formed in a sheath) that is filled with a protective material after being tensioned. The prestressing cables can be positioned on the inside (embedded in the structure to be stressed) or on the outside of the concrete (the cables are anchored to the structure via their sole anchoring points at the ends). In all cases, the post-stressing of the concrete is obtained firstly by applying concrete to a structure (for example a beam) comprising a duct (for example a sheath) without reinforcements. Reinforcements are subsequently threaded into this duct and then tensioned. Once the reinforcements have been tensioned, a grout is injected into the sheath in order to ensure the longevity of the cables on the one hand, notably by protecting them against corrosion, and in order to transfer forces to the concrete of the structure, in the event of a prestress internal to and bonded to the concrete, on the other hand.

A grout is generally composed of a mixture based on cement and water, the mixture being fluid enough to fill the duct and coat the bundle of reinforcements without leaving any gaps. The cement is a hydraulic binder, that is to say a binder that can set in the water. A conventional cement is in the form of a very fine powder, which, when mixed with the water, forms a paste which sets and hardens gradually over time. A well-known example of conventional cement is Portland cement. The cement hardens due to the hydration of certain mineral compounds. The base composition of current cements is a mixture of calcium silicates and aluminates, resulting from the combination of lime (CaO) with silica (SiO₂), alumina (Al₂O₃) and iron oxide (Fe₂O₃). The necessary lime is provided by limestone rocks; the alumina, silica and iron oxide are provided by clays. These materials are found in nature in the form of limestone, clay or marl and contain, in addition to the oxides already mentioned, other oxides and in particular Fe₂O₂, ferrous oxide. The water-cement suspension, that is to say the mixture based on cement and water, is always admixed to improve the fluidity and slow down the setting; this mixture is referred to as cement slurry.

Observations of works demonstrate that the corrosion of the post-tensioning cables can occur (possibly prematurely) at points where the grout might fail (because of the presence of pockets or bubbles filled with air and/or aqueous solution), the location of these failures depending notably on the routing of the prestressing cables. For example, as illustrated in FIG. 1, the prestressing cables 10 often have a sinuous trajectory having top points 12 and bottom points 13, the prestressing force exerted by the cable 10 being directed downward in the vicinity of the top points, and vice versa. At these top points 12, an absence of grout in contact with the cable reinforcements 10 and the presence of air and/or aqueous solution or else particles less dense than the cement can be observed, this possibly promoting the corrosion of the reinforcements. For the cement slurries, the absence of grout originates from a lack of stability of the grout or filling imperfections in the injection operation. The lack of stability of the grout manifests itself in a phenomenon of segregation of the grout in the duct, by sedimentation (solid deposit) or filtration (water rising along the reinforcements), which can consequently lead to a phenomenon of bleeding. In order to avoid this phenomenon, the injection of the grout into the duct must be done without driving air into or trapping it in the duct, particularly at the top points or behind the reinforcements. Moreover, the grout, once it has hardened, must be chemically stable and provide protection for the constituent steel of the cables throughout the service life of the work. Furthermore, in order to be injected, the grout must be fluid enough to be pumped and channeled in the hoses and the ducts and must remain stable and homogeneous before and after setting. It is therefore necessary to manage the bleeding.

The fluidity of the grout is a critical point that is difficult to manage owing to the inconsistency of the production of the cement, variations in climate during the injection operations, the implementation pressures exerted, the kinematics of the grout advancing in the duct, filtration through the reinforcements, etc.

More specifically, the fluid grout is a suspension of cement grains dispersed in a large amount of water containing adjuvants, the roles of which in general are to thin and slow down the setting of the mixture. The cement sets by way of a phenomenon of hydration, in which the water is the main reagent that triggers a crystallization reaction. There is always excess water in the grout. In general, the grouts are metered with a mass ratio of water to cement which is about 0.34 to 0.40, whereas the proportion of water required to hydrate the cement particles is only approximately 0.17. If the suspension is stable, the excess water is converted into microporosities that are distributed in the hardened material as it sets. Otherwise, segregation effects caused by filtration and/or sedimentation occur, which result in the rising of water into the top points before the setting, and sometimes the rising of particles of materials less dense than the cement. When this occurs, these particles form, at the top points of the routing of the cables, an accumulation of “white paste”, which does not harden and has chemical properties which are different from those of the hardened grout. This effect can be combined with the presence of pockets of air and water at the top points if the injection is not correctly managed. It is precisely in these areas in which the injection fails where it is potentially possible to observe premature breakage of the cables caused by corrosion of the steel in the reinforcements. Specifically, the relatively large amount of water, although it is required for the chemical hydration reaction, exhibits drawbacks, such as bleeding or accumulation of white paste.

What is known, for example, according to the patent EP0875636A1, is a solution aiming to remedy the problems of poor injection by adding vents at the top points of the cable, which make it possible for the air and water that could be in contact with the reinforcements to escape the duct. However, this solution is not satisfactory, since discharge through the vent requires multiple subsequent steps of reinjecting grout into the duct. This solution is therefore lengthy and difficult to implement.

Other known solutions consist in replacing the cement slurry with a substitute for this slurry, such as for example inhibitor gels, petroleum waxes or organic resins. These substitutes exhibit numerous drawbacks, such as for example a lack of bonding between the injected product and the prestressing reinforcements, or, for waxes, implementation at high temperature, notably in order to be within a temperature range above the melting point of the substitute used, and thus obtain a low-viscosity and therefore injectable fluid. This implementation under hot conditions moreover causes shrinkage (or retraction) when the product cools down.

Another alternative consists in replacing the cement slurry with a grout of alternative composition. Document FR2623492A1, for example, discloses a cement slurry comprising a mineral filler, such as sand, for example.

A mineral material can also be envisaged. This type of material is stable in liquid form and requires only a small amount of water compared with a cement slurry intended for injection. This involves products of poly(silico-oxo-aluminate) type, commonly referred to as “geopolymers”. Because there is no cement in a geopolymer grout, the hydration reaction of the mixture does not interfere with the setting and hardening of the grout. The problems caused by the presence of a large amount of water in the grout are thus avoided. This type of material is known, for example, from document FR2949227A1. The geopolymer grout disclosed in that document affords performance in terms of rheology and mechanical strength defined by a specification wherein, 28 days after manufacture, the compressive strength of the grout should be greater than 30 MPa. However, this material does not meet the conventional criteria of fluidity required to inject the grout. This fluidity is usually measured in accordance with a standardized test described in the European standard “NF EN 445” concerning the flow time through a Marsh cone with a 10 mm diameter nozzle, which should theoretically stay less than or equal to 25 seconds, 5 hours after kneading the grout (equivalent to a viscosity of 0.5 Pa.$).

Moreover, the grout should be able to be injected into a duct intended to contain taut reinforcements. Document FR2713690A1 discloses a process for injecting a grout. However, this process is specifically designed for a cement slurry and therefore cannot be used for a geopolymer grout.

The grout proposed by the invention therefore aims to solve the problems encountered for known grouts that set, whether this involves cement slurry or geopolymer grout. Thus, the grout disclosed by the present invention aims notably to solve the problems that lead both to the presence of water in the cement slurry and the lack of fluidity of existing geopolymer grouts.

### SUMMARY OF THE INVENTION

The invention proposes a geopolymer grout for protecting prestressing reinforcements, the geopolymer grout comprising metakaolin, fly ash and an activator mixture, the activator mixture comprising sodium hydroxide and sodium silicate, wherein the Na₂O:SiO₂ molar ratio of the sodium silicate is between 0.40 and 0.70. In particular, the Na₂O:SiO₂ molar ratio of the sodium silicate is between 0.51 and 0.60.

In the geopolymer grout, the sodium silicate may moreover exhibit a mass content of water of between 52.1% and 72.1%, and the activator mixture may exhibit a mass content of water less than 65%.

In the geopolymer grout, the activator mixture may moreover exhibit a mass content of water of between 40% and 65%. In particular, the mass content of water is between 56% and 63%.

In the geopolymer grout, the metakaolin:fly ash:alkaline silicate solution:sodium hydroxide mass ratio may be 1:1:2-3:0.15-0.35.

In the geopolymer grout, the metakaolin:fly ash:alkaline silicate solution:sodium hydroxide mass ratio may moreover be 1:1:2.4-2.6:0.19-0.23.

The geopolymer grout may moreover have a pH of between 13 and 14.

The geopolymer grout may moreover exhibit reaction-aqueous-solution bleeding less than 0.5% of the total mass of the grout.

In the geopolymer grout, the BET specific surface area (Brunauer-Emmett-Teller theory) of the metakaolin alone or of a mixture comprising the metakaolin and the fly ash may be greater than or equal to 25 m²/g and preferably greater than or equal to 30 m²/g.

The invention also proposes a process for manufacturing a geopolymer grout, the geopolymer grout comprising metakaolin, fly ash and an activator mixture, the activator mixture comprising sodium hydroxide and sodium silicate, the Na₂O:SiO₂ molar ratio of the sodium silicate being between 0.40 and 0.70, wherein the manufacturing process comprises an activation step in which the metakaolin and the fly ash are activated by the activator mixture in order to obtain polymerization of the aggregate.

The manufacturing process may moreover comprise a prior step of homogenizing the metakaolin and the fly ash.

The manufacturing process may moreover comprise a kneading step in which the activator mixture is kneaded with the metakaolin and the fly ash.

In one embodiment of the manufacturing process, water is added at the start of the kneading step, the amount of water added being between 1% and 4% of the weight of the geopolymer grout. The water added is useful only for improving the fluidity of the grout. This is because the water is not necessary for the polymerization step, thereby minimizing its use. In relation to the amounts of metakaolin, fly ash and activator mixture that are required to manufacture the grout, water thus represents a marginal amount, thus avoiding the risks associated with quality and stability when the grout is setting.

In one embodiment of the manufacturing process, in a prior milling step, the metakaolin alone or a mixture comprising the metakaolin and the fly ash is milled in order to obtain a BET specific surface area greater than or equal to 25 m²/g and preferably greater than or equal to 30 m²/g.

The invention also proposes a process for installing a structural cable, comprising the following steps:
fitting a duct containing at least one reinforcement,
tensioning the reinforcement,
injecting a geopolymer grout into the duct, and
   wherein the geopolymer grout comprises metakaolin, fly ash and an activator mixture, the activator mixture comprising sodium hydroxide and sodium silicate, the Na₂O:SiO₂ molar ratio of the sodium silicate being between 0.40 and 0.70.

The installation process may moreover comprise, before injecting the geopolymer grout into the duct, a step of kneading the geopolymer grout for 2 to 5 minutes with an energy of approximately 9 kilojoules per liter, thus obtaining an equivalent fluidity through a Marsh cone with a 10 mm diameter nozzle of between 25 seconds and 35 seconds.

The installation process may moreover comprise, during the injection of the geopolymer grout into the duct, the use of a hose, the hose having an inside diameter greater than 25 mm and a length limited to 100 m.

In one embodiment of the installation process, the grout is pumped during the injection, the pumping flow rate of the grout being between 0.5 m³/h and 1.5 m³/h.

It should be noted that neither the process for manufacturing the geopolymer grout nor the installation process requires a step of heating the components of the geopolymer grout or the grout itself. These processes can be implemented at ambient temperature, by contrast for example with the injection of petroleum wax, which requires the wax to be heated above its melting point. As a result, the phenomenon of retraction of the geopolymer wax after being injected is insignificant or even nonexistent.

### BRIEF DESCRIPTION OF THE DRAWINGS

Other features, details and advantages of the invention will become apparent from reading the description set out below and from analyzing the appended drawings, in which:

FIG. 1

FIG. 1 is a basic diagram illustrating an example of a prestressing cable.

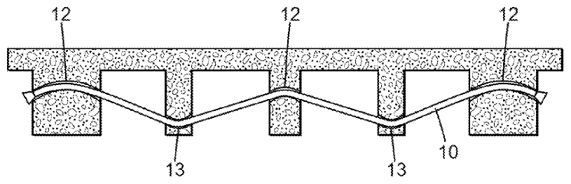

### DESCRIPTION OF EMBODIMENTS

The geopolymer grout according to the invention is a mineral material in stable liquid form, the formulation of which does not comprise any or comprises only very little free water. More specifically, this involves a product of poly(silico-oxo-aluminate), or (—Si—O—Al—O)n (in which n is the degree of polymerization), type. This geopolymer grout is particularly advantageous for protecting prestressing cables in their duct. This is because this grout ensures better filling of the duct and better coating of the reinforcements, whilst still having no adverse effect on the prestressing reinforcement.

The geopolymer grout mainly comprises powders, referred to as filler elements, and a liquid activator mixture. The filler elements are a metakaolin and fly ash.

The metakaolin is also referred to as calcined kaolin. The metakaolin is a dehydroxylated aluminum silicate with the overall composition Al₂O₃, 2Si₂O₂. The metakaolin is, for example, a powdered product sold under the name Argical 1200®, the composition of which is detailed in the following table, [table 1].

TABLE 1

| | | | |
|---|---|---|---|
| SiO₂ | 55% | Fe₂O₃ | 1.8% |
| Al₂O₃ | 39% | TiO₂ | 1.5% |
| K₂O + Na₂O | 1.0% | CaO + MgO | 0.6% |

The above table, [table 1], sets out the chemical composition of the metakaolin with the commercial name Argical 1200®.

The metakaolin used is finely milled. More specifically, the metakaolin has a BET specific surface area greater than 15 m²/g. With preference, the BET specific surface area is greater than 25 m²/g. For example, the BET specific surface area of the metakaolin is greater than 30 m²/g. The metakaolin makes it possible notably to obtain a smoother grout than with a conventional cement, by limiting the deposits of mineral salts on the surface of the cement (also referred to as “efflorescence”). Furthermore, the fineness of milling of the metakaolin makes it possible to improve the mechanical strength in compression and to reduce the viscosity of the geopolymer grout obtained. Specifically, among the filler elements, increasing the proportion of metakaolin in relation to the proportion of fly ash increases the mechanical strength and viscosity of the grout. Since the metakaolin has an elongate and irregular shape, whereas the fly ash has a spherical shape, milling the metakaolin improves its properties of stacking with the fly ash, thereby increasing the proportion of metakaolin among the filler elements. Moreover, the metakaolin is a component the extraction of which requires little energy in relation to an ordinary cement, thereby making the manufacture of the geopolymer grout advantageous from an environmental perspective. This is because the manufacture of metakaolin is obtained by calcining kaolinite (natural clay), which can be performed at low temperature (between 600° C. and 800° C.) in relation to the manufacture of a cement which requires chemically combining clay and limestone at very high temperature (about 1450° C.).

The fly ash is class F fly ash. More specifically, the fly ash used originates from the combustion of pulverized coal in the boilers of thermoelectric power stations, by collecting it in electrostatic precipitators. For example, the fly ash used is sold under the trade name “Silicoline®”. The fly ash makes it possible notably to improve the handling of the grout and the mechanical performance thereof in the long term.

The fly ash used may be finely milled. in this case, the fly ash exhibits a BET specific surface area greater than 15 m²/g. With preference, the BET specific surface area is greater than 25 m²/g. For example, the BET specific surface area of the fly ash is greater than 30 m²/g. The fineness of milling of the fly ash makes it possible to improve the mechanical strength in compression of the geopolymer grout obtained.

The activator mixture comprises sodium hydroxide, sodium silicate and water. The activator mixture makes it possible to initiate the chemical reactions by breaking the chemical bonds of the metakaolin and fly ash elements in order to form an amorphous gel, and then to trigger the polymerization reaction and to polymerize the aggregate in order to obtain the geopolymer having a three-dimensional structure containing the Si—O—Al bond.

The sodium silicate is an alkaline silicate solution. More specifically, the sodium silicate exhibits an Na₂O:SiO₂ molar ratio of between 0.40 and 0.70. For example, the molar ratio is preferably between 0.51 and 0.60. For example, the molar ratio is between 0.55 and 0.59. According to another example, the molar ratio is 0.57. Moreover, the sodium silicate exhibits a mass content of water of between 52.1% and 72.1%. For example, the sodium silicate comprises 62.1% of its weight in water.

The sodium hydroxide is initially in the form of sodium hydroxide pellets. The sodium hydroxide pellets are incorporated in the sodium silicate solution in a sodium hydroxide:sodium silicate mass ratio of 8.53:100. For example, 85.3 g sodium hydroxide are incorporated in 1000 g sodium silicate solution. The basic nature of the sodium hydroxide makes it possible to increase the pH of the geopolymer grout, this promoting the protection of the reinforcements against corrosion. For example, the grout has a pH of between 13 and 14. According to another example, the geopolymer grout has a pH of between 13.3 and 13.5. According to a preferential example, the geopolymer grout has a pH close to 13.4. Consequently, if the grout must exhibit a bleeding phenomenon which will be only very limited on account of the marginal amount of water added, the aqueous solution for bleeding has a basic pH comprised within the ranges set out above. The water for bleeding therefore does not cause corrosion of the reinforcements. In particular, the grout may exhibit aqueous-solution bleeding less than 0.5% of the total mass of the grout.

The sodium hydroxide moreover makes it possible to obtain adequate Na/Si or Na/Al molar ratios, thereby making it possible to obtain a geopolymer grout with a chemical formulation that meets the criteria sought.

The activator mixture moreover comprises water. Water is understood here to mean water that is added, further to water that forms part of the composition of the sodium silicate solution. Consequently, the water described here does not form part of the water making up the sodium silicate and is therefore excluded from the range of 52.1% to 72.1% of the mass content of water of the sodium silicate mentioned above. The added water represents less than 4% of the total mass of the geopolymer grout. “Total mass of the geopolymer grout” is understood to mean the mass of the grout comprising the metakaolin, the fly ash, the sodium hydroxide, the sodium silicate and the added water. For example, the added water represents between 1% and 4% of the total mass of geopolymer grout. According to another example, the added water represents between 1% and 2% of the total mass of the geopolymer grout, and preferably 1.86%. According to yet another example, the added water represents between 3% and 4% of the total mass of the geopolymer grout. and preferentially 3.64%. This amount remains marginal in relation to the total mass of the geopolymer grout.

In other words, the activator mixture exhibits a mass content of water less than 65%. In this case, the mass content of water takes into account the water present in the sodium silicate as such and the water added to the sodium silicate and to the sodium hydroxide. Consequently, the mass content in this case is a ratio between the mass of water present in the sodium silicate and the water added, and the total mass of the activator mixture (that is to say the sodium silicate, the sodium hydroxide and the added water). For example, the activator mixture exhibits a mass content of water of between 40% and 65%, and for example between 56% and 63%. For example, the activator mixture exhibits a mass content of water of between 58% and 59%. According to another example, the activator mixture exhibits a mass content of water of between 59% and 60%.

Advantageously, the addition of water to the activator mixture makes it possible to improve the fluidity of the geopolymer grout while reducing the mechanical strength after setting and hardening only to a limited extent, said mechanical strength still meeting the criterion requiring the compressive strength of the grout to be greater than 30 MPa at 28 days.

The geopolymer grout of the invention has the advantage of causing only very limited bleeding and of better homogeneity of the grout, given the small amount of water incorporated. Furthermore, this small amount of water results in no filtration in the bundles of reinforcements making up the cable. Another result of the small amount of added water is a porosity of the geopolymer grout which is much lower than a porosity of the cement slurry of the prior art. For example, the porosity of the geopolymer grout set out here exhibits a porosity at least six times lower than the porosity of a cement slurry. In addition, the kinetic advancement of injection of the geopolymer grout in the duct is facilitated and the grout more easily coats the reinforcements than a conventional cement slurry does, this preventing the appearance of hidden air pockets (or bubbles).

The geopolymer grout is manufactured by the process set out below, comprising some alternatives.

In an initial step, the metakaolin and the fly ash are homogenized in a mechanical mixer.

As an alternative, beforehand, the metakaolin alone (that is to say without the fly ash) is milled in order to obtain a BET specific surface area greater than or equal to 25 m²/g and preferably greater than or equal to 30 m²/g. For example, the metakaolin is milled using a mill. The mill used may be a ring mill or a ball mill. According to another alternative, the filler elements (that is to say the metakaolin and the fly ash) are milled in order to obtain a BET specific surface area greater than or equal to 25 m²/g and preferably greater than or equal to 30 m²/g.

In the case of a ball mill, for example, a mass of 5 kg metakaolin is introduced and milled for 12 h at a speed of 39 revolutions per minute. As a function of the milling time, various BET specific surface areas for the metakaolin are obtained, some examples of which are collated in the following table, [table 2].

TABLE 2

| | BET specific |
|---|---|
| milling | surface area |
| time (h) | (m²/g) |
| 0 | 18 |
| 3 | 26 |
| 6 | 30 |
| 9 | 34 |
| 12 | 36 |

The above table, [table 2], illustrates the milling of 5 kg metakaolin by a ball mill at a speed of 39 revolutions per minute.

Subsequently, the sodium silicate solution incorporating the sodium hydroxide pellets is prepared. For example, a dose of 85.3 g sodium hydroxide is incorporated for 1000 g sodium silicate solution. The mixture is stirred until the sodium hydroxide pellets have completely dissolved.

Subsequently, in a kneading step, the activator mixture is kneaded with the metakaolin and the fly ash. This step makes it possible to obtain polymerization of the aggregate and consequently the geopolymer grout.

More specifically, the mixture of metakaolin and fly ash is introduced into the activator solution. The aggregate is then kneaded enough to ensure deflocculation of the mixture (homogeneous mixture without lumps).

The water is then added to the aggregate. The addition of water makes it possible to thin the mixture so as to obtain a geopolymer grout having a fluidity through a Marsh cone (with a 10 mm diameter nozzle) of between 25 seconds and 35 seconds, for example 30 seconds.

As an alternative, the water is added before the aggregate is mixed. According to another alternative, the water is added during the mixing. Specifically, the moment at which the water is added during the mixing step does not modify the properties in terms of rheology and mechanical strength of the geopolymer grout. In particular, it must be understood that the water added does not contribute to the polymerization of the aggregate. In other words, the water is not a reactive constituent in the polymerization step. The addition of water to the mixture is therefore independent of the polymerization.

As an alternative, the aggregate is subsequently left to stand for 90 seconds.

Then, the aggregate is mixed for 60 seconds at a speed of 630 revolutions per minute, for example.

By way of example, the geopolymer grout prepared has the features collated in the following table, [table 3].

TABLE 3

| | | | Formulation 1 | Formulation 2 | Formulation 3 |
|---|---|---|---|---|---|
| grout | metakaolin (g) | | 112.5 | 112.5 | 112.5 |
| geopolymer | milling of the metakaolin | | no | Milling of | Co-milling of |
| | | | | metakaolin | metakaolin + |
| | | | | alone | fly ash |
| | fly ash (g) | | 112.5 | 112.5 | 112.5 |
| | activator | sodium silicate (g) | 280 | 280 | 280 |
| | mixture | water (g) | 20 | 10 | 10 |
| | | sodium hydroxide (g) | 23.884 | 23.884 | 23.884 |

The above table, [table 3], collates examples of the formulation of geopolymer grout.

Consequently, the geopolymer grout has a metakaolin:fly ash:alkaline silicate solution:sodium hydroxide ratio of 1:1:2-3:0.15-0.35. For example, the mass ratio is 1:1:2.4-2.6:0.19-0.23. With preference, as illustrated in the formulation examples in the table, [table 3], the mass ratio is 1:1:2.489:0.212.

Rheology measurements and mechanical strength tests were carried out on the geopolymer grout obtained, in accordance with the test methods of the standard NF EN 445. The results are collated in the following table, [table 4].

TABLE 4

| | Compressive | |
|---|---|---|
| | strength at 7 days | Viscosity |
| | (MPa) | (Pa · s) |
| Formulation 1 | 29.7 | 0.90 |
| Formulation 2 | 36.3 | 0.68 |
| Formulation 3 | 39.4 | 0.76 |

The above table, [table 4], collates the results in terms of compressive strength and viscosity measurements.

The process for installing a structural cable will now be described. The installation process mainly comprises the fitting of a duct containing at least one reinforcement and tensioning the reinforcement, and then injecting a geopolymer grout into the duct.

Once the geopolymer grout has been prepared according to the manufacturing process described above, the geopolymer grout is kneaded in order to obtain sufficient fluidity, measured through a Marsh cone in accordance with the standard NF EN 445, of between 25 seconds and 45 seconds. For example, the geopolymer grout is kneaded for 2 to 5 minutes (for example 4 minutes) with an energy of approximately 9 kilojoules per liter. The kneading is done, for example, by a turbo-type kneader for dispersing an energy of approximately 9 kilojoules per liter into the mixture. This kneading is an important step in the injection process since it makes it possible to improve the fluidity as well, in other words to reduce the flow time measured through a Marsh cone. Specifically, the geopolymer mixture before turbo-kneading may have a flow time greater than 50 seconds, whereas the turbo-kneading described above makes it possible to lower this to a value of between 25 and 45 seconds (viscosity values of between 0.5 and 0.9 Pa.$). These values for the flow time can remain greater than the usual criteria of the standard NF EN 445 (time less than or equal to 25 seconds) without preventing the injection of the grout.

Then, the geopolymer grout is injected into the duct through a hose. The hose has, for example, an inside diameter greater than 25 mm. With preference, the inside diameter of the hose is greater than 35 mm. Moreover, the hose has a length for example limited to 100 m. The injection of the geopolymer grout is done, for example, by means of a pump (of nominal pressure 25 bar) with a pumping flow rate of between 0.5 m³/h and 1.5 m³/h.

By virtue of this installation process, the geopolymer grout stays stable (that is to say homogeneous via the lack of segregation). Specifically, no bleeding is observed around and through the constituent reinforcements of the cable. In comparison with a cement slurry, any risk associated with a bad hydration reaction, and notably the obtention of an unstable grout, is thus avoided here. After the geopolymer grout has set and hardened, it is possible for the cavities or bubbles to contain re-emerged aqueous solutions with a pH of between 13 and 13.5 that represent less than 0.5% of the mass of the grout. The composition of these solutions contains the main chemical elements from the various components (sodium ions Nat, sulfates SO₄²⁻, silicate H₂SiO₄²⁻, and aluminates Al(OH)₄⁻), these not exhibiting any risk in terms of protecting the reinforcements against corrosion. Furthermore, the residual air volume in the duct is six times smaller than that of a conventional cement slurry. It has also been observed that, when the duct into which the geopolymer grout is injected is inclined, the geopolymer grout advances with a front that is only slightly offset between the upper and lower portions of the duct.

1. A geopolymer grout for protecting prestressing reinforcements, the geopolymer grout comprising metakaolin, fly ash and an activator mixture, the activator mixture comprising sodium hydroxide and sodium silicate, wherein the Na₂O:SiO₂ molar ratio of the sodium silicate is between 0.40 and 0.70.

2. The geopolymer grout as claimed in claim 1, the sodium silicate having a mass content of water of between 52.1% and 72.1%, and the activator mixture having a mass content of water less than 65%.

3. The geopolymer grout as claimed in claim 2, wherein the activator mixture has a mass content of water of between 40% and 65%.

4. The geopolymer grout as claimed in claim 1, wherein the metakaolin:fly ash:alkaline silicate solution:sodium hydroxide mass ratio is 1:1:2-3:0.15-0.35.

5. The geopolymer grout as claimed in claim 1, wherein the grout exhibits aqueous-solution bleeding less than 0.5% of the total mass of the grout.

6. The geopolymer grout as claimed in claim 1, wherein the grout has a pH of between 13 and 14.

7. The geopolymer grout as claimed in claim 1, wherein the BET specific surface area of the metakaolin alone or of a mixture comprising the metakaolin and the fly ash is greater than or equal to 25 m²/g and preferably greater than or equal to 30 m²/g.

8. A process for manufacturing a geopolymer grout, the geopolymer grout comprising metakaolin, fly ash and an activator mixture, the activator mixture comprising sodium hydroxide and sodium silicate, the Na₂O:SiO₂ molar ratio of the sodium silicate being between 0.40 and 0.70, wherein the manufacturing process comprises an activation step in which the metakaolin and the fly ash are activated by the activator mixture in order to obtain polymerization of the aggregate.

9. The manufacturing process as claimed in claim 8, moreover comprising a prior step of homogenizing the metakaolin and the fly ash.

10. The manufacturing process as claimed in claim 8, moreover comprising a kneading step in which the activator mixture is kneaded with the metakaolin and the fly ash.

11. The manufacturing process as claimed in claim 10, wherein water is added at the start of the kneading step, the amount of water added being between 1% and 4% of the weight of the geopolymer grout.

12. The manufacturing process as claimed in claim 8, wherein, in a prior milling step, the metakaolin alone or a mixture comprising the metakaolin and the fly ash is milled in order to obtain a BET specific surface area greater than or equal to 25 m²/g and preferably greater than or equal to 30 m²/g.

13. A process for installing a structural cable, comprising the following steps:
fitting a duct containing at least one reinforcement,
tensioning the reinforcement,
injecting a geopolymer grout into the duct, and
wherein the geopolymer grout comprises metakaolin, fly ash and an activator mixture, the activator mixture comprising sodium hydroxide and sodium silicate, the Na₂O:SiO₂ molar ratio of the sodium silicate being between 0.40 and 0.70.

14. The installation process as claimed in claim 13, comprising, before injecting the geopolymer grout into the duct, a step of kneading the geopolymer grout for 2 to 5 minutes with an energy of approximately 9 kilojoules per liter, thus obtaining a fluidity through a Marsh cone with a 10 mm diameter nozzle of between 25 seconds and 35 seconds.

15. The installation process as claimed in claim 13, wherein, during the injection, the geopolymer grout is injected into the duct through a hose, the hose having an inside diameter greater than 25 mm and a length limited to 100 m.

16. The process as claimed in claim 15, wherein the grout is pumped during the injection, the pumping flow rate of the grout being between 0.5 m³/h and 1.5 m³/h.
